(19) United States
(12) Patent Application Publication
(10) Pub. No.: US 2021/0399291 A1
(43) Pub. Date: Dec. 23, 2021

(54) PROCESS FOR MAKING A COATED OXIDE MATERIAL

(71) Applicant: BASF SE, Ludwigshafen (DE)

(72) Inventors: Maraike AHLF, Ludwigshafen (DE); Torsten MAEURER, Ludwigshafen (DE); Christoph ERK, Ludwigshafen (DE); Jacob HAAG, Amagasaki (JP); Heino SOMMER, Ludwigshafen (DE)

(21) Appl. No.: 17/309,205

(22) PCT Filed: Nov. 11, 2019
(86) PCT No.: PCT/EP2019/080834

§ 371 Date: May 6, 2021

(30) Foreign Application Priority Data
Nov. 16, 2018 (EP) 18206660.5

(51) Int. Cl. H01M 4/36; H01M 4/525; H01M 10/0525; H01M 4/505

(52) U.S. Cl. CPC H01M 4/366; H01M 4/525; H01M 2004/021; H01M 4/505; H01M 10/0525

(57) ABSTRACT

Process for making a coated oxide material wherein said process comprises the following steps: (a) providing a particulate material selected from lithiated nickel-cobalt aluminum oxides, lithium cobalt oxide, lithiated cobalt-manganese oxides and lithiated layered nickel-cobalt-manganese oxides, (b) treating said particulate material with an aqueous medium, (c) removing said aqueous medium, (d) drying said treated particulate material, (e) treating said particulate material from step (d) with a metal amide or alkyl metal compound, (f) treating the material obtained in step (e) with moisture or an oxidizing agent, and, optionally, repeating the sequence of steps (e) and (f).

The present invention is directed towards a process for making a coated oxide material wherein said process comprises the following steps:
(a) providing a particulate material selected from lithiated nickel-cobalt aluminum oxides, lithium cobalt oxide, lithiated cobalt-manganese oxides and lithiated layered nickel-cobalt-manganese oxides,
(b) treating said particulate material with an aqueous medium,
(c) removing said aqueous medium,
(d) drying said treated particulate material,
(e) treating said particulate material from step (d) with a metal amide or alkyl metal compound,
(f) treating the material obtained in step (e) with moisture or an oxidizing agent, and, optionally, repeating the sequence of steps (e) and (f).

In addition, the present invention is directed towards Ni-rich electrode active materials.

Lithium ion secondary batteries are modern devices for storing energy. Many application fields have been and are contemplated, from small devices such as mobile phones and laptop computers through car batteries and other batteries for e-mobility. Various components of the batteries have a decisive role with respect to the performance of the battery such as the electrolyte, the electrode materials, and the separator. Particular attention has been paid to the cathode materials. Several materials have been suggested, such as lithium iron phosphates, lithium cobalt oxides, and lithium nickel cobalt manganese oxides. Although extensive research has been performed the solutions found so far still leave room for improvement.

Currently, a certain interest in so-called Ni-rich electrode active materials may be observed, for example electrode active materials that contain 75 mole-% or more of Ni, referring to the total TM content.

One problem of lithium ion batteries—especially of Ni-rich electrode active materials—is attributed to undesired reactions on the surface of the electrode active materials. Such reactions may be a decomposition of the electrolyte or the solvent or both. It has thus been tried to protect the surface without hindering the lithium exchange during charging and discharging. Examples are attempts to coat the electrode active materials with, e.g., aluminium oxide or calcium oxide, see, e.g., U.S. Pat. No. 8,993,051.

Other theories link undesired reactions to free LiOH or Li₂CO₃ on the surface. Attempts have been made to remove such free LiOH or Li₂CO₃ by washing the electrode active material with water, see, e.g., JP 4,789,066 B, JP 5,139,024 B, and US2015/0372300. However, in some instances it was observed that the properties of the resultant electrode active materials did not improve.

It was an objective of the present invention to provide a process for making electrode active materials with excellent electrochemical properties. It was especially an objective to provide so-called Ni-rich electrode active materials with excellent electrochemical properties.

Accordingly, the process defined at the outset has been found, hereinafter also referred to as “inventive process”.

The inventive process comprises several steps, in the context of the present invention also referred to as step (a) to step (f). The commencement of steps (b) and (c) may be simultaneously or preferably subsequently. Step (d) is performed after step (c). Steps (e) and (f) may repeated. The various steps are described in more detail below.

Step (a) includes providing a particulate material selected from lithiated nickel-cobalt aluminum oxides, lithium cobalt oxide, lithiated cobalt-manganese oxides and lithiated layered nickel-cobalt-manganese oxides.

The formula of lithium cobalt oxide is LiCoO₂. Examples of lithiated layered cobalt-manganese oxides are Li₁₊ₓ(CoₑMn_{f}M³_{d})₁₋ₓO₂. Examples of layered nickel-cobalt-manganese oxides are compounds of the general formula Li₁₊ₓ(NiₐCo_{b}Mn_{c}M³_{d})₁₋ₓO₂, with M³ being selected from Mg, Ca, Ba, Al, Ti, Zr, Zn, Mo, V and Fe, the further variables being defined as follows:

zero≤x≤0.2

0.1≤a≤0.9,

zeros≤b≤0.5,

0.1≤c≤0.6,

zero≤d≤0.1, and a+b+c+d=1.

In a preferred embodiment, in compounds according to general formula (I)

Li₍₁₊ₓ₎[NiₐCo_{b}Mn_{c}M³_{d}]₍₁₋ₓ₎O₂

M³ is selected from Ca, Mg, Al and Ba,

and the further variables are defined as above.

In a particularly preferred embodiment, TM is a combination of metals according to general formula (I a)

(NiₐCo_{b}Mn_{c})_{1-d}M¹_{d} (I a)

with a+b+c=1 and

a being in the range of from 0.75 to 0.95,

b being in the range of from 0.025 to 0.2,

c being in the range of from 0.025 to 0.2, and

d being in the range of from zero to 0.1,

and M¹ is at least one of Al, Mg, W, Mo, Nb, Ti or Zr.

In Li₁₊ₓ(CoₑMn_{f}M³_{d})₁₋ₓO₂, e is in the range of from 0.2 to 0.8, f is in the range of from 0.2 to 0.8, the variables M³ and d and x are as defined above, and e+f+d=1.

Examples of lithiated nickel-cobalt aluminum oxides are compounds of the general formula Li[NiₕCoᵢAlⱼ]O₂₊ᵣ. TM is thus is a combination of metals according to general formula (I b)

[NiₕCoᵢAlⱼ] (I b)

wherein

h is in the range of from 0.8 to 0.95,

i is in the range of from 0.025 to 0.19,

j is in the range of from 0.01 to 0.05.

The variable r is in the range of from zero to 0.4.

Specific examples are Li₍₁₊ₓ₎[Ni_{0.33}Co_{0.33}Mn_{0.33}]₍₁₋ₓ₎O₂, Li₍₁₊ₓ₎[Ni_{0.5}Co_{0.2}Mn_{0.3}]₍₁₋ₓ₎O₂, Li₍₁₊ₓ₎[Ni_{0.6}Co_{0.2}Mn_{0.2}]₍₁₋ₓ₎O₂, Li₍₁₊ₓ₎[Ni_{0.85}Co_{0.1}Mn_{0.05}]₍₁₊ₓ₎O₂, Li₍₁₊ₓ₎[Ni_{0.7}Co_{0.2}Mn_{0.1}]₍₁₋ₓ₎O₂, and Li₍₁₊ₓ₎[Ni_{0.8}Co_{0.1}Mn_{0.1}]₍₁₋ₓ₎O₂, each with x as defined above.

Some elements are ubiquitous. In the context of the present invention, traces of ubiquitous metals such as sodium, calcium, iron or zinc, as impurities will not be taken into account in the description of the present invention. Traces in this context will mean amounts of 0.05 mol-% or less, referring to the total metal content of the particulate material.

Said particulate material is preferably provided without any additive such as conductive carbon or binder but as free-flowing powder. In particular, the particulate material is preferably free from conductive carbon, that means that the conductive carbon content of particulate material is less than 1% by weight, referring to said particulate material, preferably 0.001 to 1.0% by weight or even below detection level.

In one embodiment of the present invention the particulate material has an average particle diameter (D50) in the range of from 3 to 20 μm, preferably from 5 to 16 μm. The average particle diameter can be determined, e. g., by light scattering or LASER diffraction or electroacoustic spectroscopy. The particles are usually composed of agglomerates from primary particles, and the above particle diameter refers to the secondary particle diameter.

In one embodiment of the present invention, the particulate material has a specific surface (BET), hereinafter also referred to as “BET surface”, in the range of from 0.1 to 1.0 m²/g. The BET surface may be determined by nitrogen adsorption after outgassing of the sample at 200° C. for 30 minutes or more in accordance with DIN ISO 9277:2010.

In step (b), said particulate material is treated with an aqueous medium. Said aqueous medium may have a pH value in the range of from 2 up to 14, preferably at least 5, more preferably from 7 to 12.5 and even more preferably from 8 to 12.5. The pH value is measured at the beginning of step (b). It is observed that in the course of step (b), the pH value raises to at least 10.

It is preferred that the water hardness of aqueous medium and in particular of the water used for step (b) is at least partially removed, especially calcium. The use of desalinized water is preferred.

In an alternative embodiment of step (b), the aqueous medium used in step (b) may contain ammonia or at least one transition metal salt, for example a nickel salt or a cobalt salt. Such transition metal salts preferably bear counterions that are not detrimental to an electrode active material. Sulfate and nitrate are feasible. Chloride is not preferred.

In one embodiment of step (b), the aqueous medium used in step (b) contains 0.001 to 10% by weight of an oxide or hydroxide or oxyhydroxide of Al, Mo, W, Ti, or Zr. In another embodiment of step (b), the aqueous medium used in step (b) contain does not contain measurable amounts of any of oxides or hydroxides or oxyhydroxides of Al, Mo, W, Ti, or Zr.

In one embodiment of the present invention, step (b) is performed at a temperature in the range of from 5 to 65° C., preferred are 10 to 35° C.

In one embodiment of the present invention, step (b) is performed at normal pressure. It is preferred, though, to perform step (b) under elevated pressure, for example at 10 mbar to 10 bar above normal pressure, or with suction, for example 50 to 250 mbar below normal pressure, preferably 100 to 200 mbar below normal pressure.

Step (b) may be performed, for example, in a vessel that can be easily discharged, for example due to its location above a filter device. Such vessel may be charged with starting material followed by introduction of aqueous medium. In another embodiment, such vessel is charged with aqueous medium followed by introduction of starting material. In another embodiment, starting material and aqueous medium are introduced simultaneously.

In one embodiment of the present invention, the volume ratio of starting material and total aqueous medium in step (b) is in the range of from 2:1 to 1:5, preferably from 2:1 to 1:2. Step (b) may be supported by mixing operations, for example shaking or in particular by stirring or shearing, see below.

In one embodiment of the present invention, step (b) has a duration in the range of from 1 minute to 30 minutes, preferably 1 minute to less than 5 minutes. A duration of 5 minutes or more is possible in embodiments wherein steps (b) and (c) are performed overlapping or simultaneously.

In one embodiment of the present invention, steps (b) and (c) are performed consecutively. After the treatment with an aqueous medium in accordance to step (b), water may be removed by any type of filtration, for example on a band filter or in a filter press.

In one embodiment of the present invention, at the latest 3 minutes after commencement of step (b), step (c) is started. Step (c) includes removing said aqueous medium from treated particulate material by way of a solid-liquid separation, for example by decanting or preferably by filtration.

In one embodiment of the present invention, the slurry obtained in step (b) is discharged directly into a centrifuge, for example a decanter centrifuge or a filter centrifuge, or on a filter device, for example a suction filter or in a belt filter that is located preferably directly below the vessel in which step (b) is performed. Then, filtration is commenced.

In a particularly preferred embodiment of the present invention, steps (b) and (c) are performed in a filter device with stirrer, for example a pressure filter with stirrer or a suction filter with stirrer.

At most 3 minutes after—or even immediately after—having combined starting material and aqueous medium in accordance with step (b), removal of aqueous medium is commenced by starting the filtration. On laboratory scale, steps (b) and (c) may be performed on a Büchner funnel, and step (b may be supported by manual stirring.

In a preferred embodiment, step (b) is performed in a filter device, for example a stirred filter device that allows stirring of the slurry in the filter or of the filter cake. By commencement of the filtration, for example pressure filtration or suction filtration, after a maximum time of 3 minutes after commencement of step (b), step (c) is started.

In one embodiment of the present invention, step (c) has a duration in the range of from 1 minute to 1 hour.

In one embodiment of the present invention, stirring in step (b) is performed with a rate in the range of from 1 to 50 rounds per minute (“rpm”), preferred are 5 to 20 rpm.

It is preferred to perform steps (b) and (c) at the same temperature.

It is preferred to perform steps (b) and (c) at the same pressure, or to increase the pressure when starting step (b).

In one embodiment of the present invention, filter media for step (c) may be selected from ceramics, sintered glass, sintered metals, organic polymer films, non-wovens, and fabrics.

In one embodiment of the present invention, steps (b) and (c) are carried out under an atmosphere with reduced CO₂ content, e.g., a carbon dioxide content in the range of from 0.01 to 500 ppm by weight, preferred are 0.1 to 50 ppm by weight. The CO₂ content may be determined by, e.g., optical methods using infrared light. It is even more preferred to perform steps (b) and (c) under an atmosphere with a carbon dioxide content below detection limit for example with infrared-light based optical methods.

In step (d), the treated material from step (c) is dried, for example at a temperature in the range of from 40 to 250° C. at a normal pressure or reduced pressure, for example 1 to 500 mbar. If drying under a lower temperature such as 40 to 100° C. is desired a strongly reduced pressure such as from 1 to 20 mbar is preferred.

In one embodiment of the present invention, step (d) is carried out under an atmosphere with reduced CO₂ content, e.g., a carbon dioxide content in the range of from 0.01 to 500 ppm by weight, preferred are 0.1 to 50 ppm by weight. The CO2 content may be determined by, e.g., optical methods using infrared light. It is even more preferred to perform step (d) under an atmosphere with a carbon dioxide content below detection limit for example with infrared-light based optical methods.

In one embodiment of the present invention step (d) has a duration in the range of from 1 to 10 hours, preferably 90 minutes to 6 hours.

In one embodiment of the present invention, the lithium content of an electrode active material is reduced by 1 to 5% by weight, preferably 2 to 4% is reduced by performing the steps (b) to (d). Said reduction mainly affects the so-called residual lithium.

In a preferred embodiment of the present invention, the material obtained from step (d) has a residual moisture content in the range of from 50 to 1,000 ppm, preferably from 100 to 400 ppm or from 600 to 1,000 ppm. The residual moisture content may be determined by Karl-Fischer titration.

In step (e), said electrode active material is treated with a metal halide or metal amide or alkyl metal compound.

In one embodiment of the inventive process, step (e) is performed at a temperature in the range of from 15 to 1000° C., preferably 15 to 500° C., more preferably 20 to 350° C., and even more preferably 50 to 200° C. It is preferred to select a temperature in step (e) at which metal amide or alkyl metal compound, as the case may be, is in the gas phase.

In one embodiment of the present invention, step (e) is carried out at normal pressure but step (e) may as well be carried out at reduced or elevated pressure. For example, step (e) may be carried out at a pressure in the range of from 5 mbar to 1 bar above normal pressure, preferably 10 to 150 mbar above normal pressure. In the context of the present invention, normal pressure is 1 atm or 1013 mbar. In other embodiments, step (e) may be carried out at a pressure in the range of from 150 mbar to 560 mbar above normal pressure.

In a preferred embodiment of the present invention, alkyl metal compound or metal amide, respectively, is selected from AI(R¹)₃, AI(R¹)₂OH, AlR¹(OH)₂, M²(R¹)_{4-y}H_{y}, Al(OR²)₃, M²[NR²)₂]₄, and methyl alumoxane, wherein

R¹ are different or equal and selected from C₁-C₈-alkyl, straight-chain or branched,

R² are different or equal and selected from C₁-C₄-alkyl, straight-chain or branched,

M² is Ti or Zr, with Ti being preferred.

Examples of aluminum alkyl compounds are trimethyl aluminum, triethyl aluminum, triisobutyl aluminum, and methyl alumoxane.

Metal amides are sometimes also referred to as metal imides. An example of metal amides is Ti[N(CH₃)₂]₄.

Particularly preferred compounds are selected from metal alkyl compounds, and even more preferred is trimethyl aluminum.

In one embodiment of the present invention, the amount of metal amide or alkyl metal compound is in the range of 0.1 to 1 g/kg particular material.

Preferably, the amount of metal amide or alkyl metal compound, respectively, is calculated to amount to 80 to 200% of a monomolecular layer on the particular material per cycle.

In one embodiment of the present invention, step (e) is performed in a rotary kiln, in an agitated mixer, e.g. in a plough share mixer or in free fall mixer, in a continuous vibrating bed or a fluidized bed. Step (e) of the inventive process as well as step (f)—that will be discussed in more detail below—may be carried out in the same or in different vessels.

In a preferred embodiment of the present invention, the duration of step (e) is in the range of from 1 second to 2 hours, preferably 1 second up to 30 minutes.

In a third step, in the context of the present invention also referred to as step (f), the material obtained in step (e) is treated with moisture.

In one embodiment of the present invention, step (f) is carried out at a temperature in the range of from 50 to 250° C.

In one embodiment of the present invention, step (f) is performed in a rotary kiln, a rotary kiln, in an agitated mixer, e.g. in a plough share mixer or in free fall mixer, in a continuous vibrating bed or a fluidized bed.

In one embodiment of the present invention, step (f) is carried out at normal pressure but step (f) may as well be carried out at reduced or elevated pressure. For example, step (f) may be carried out at a pressure in the range of from 5 mbar to 1 bar above normal pressure, preferably 10 to 250 mbar above normal pressure. In the context of the present invention, normal pressure is 1 atm or 1013 mbar. In other embodiments, step (f) may be carried out at a pressure in the range of from 150 mbar to 560 mbar above normal pressure.

Steps (e) and (f) may be carried out at the same pressure or at different pressures, preferred is at the same pressure.

Said moisture may be introduced, e.g., by treating the material obtained in accordance with step (e) with moisture saturated inert gas, for example with moisture saturated nitrogen or moisture saturated noble gas, for example argon. Saturation may refer to normal conditions or to the reaction conditions in step (f).

In a preferred embodiment of the present invention, the duration of step (f) is in the range of from 1 second to 2 hours, preferably 1 second up to 30 minutes.

In one embodiment of the present invention, the reactor in which the inventive process is carried out is flushed or purged with an inert gas between steps (e) and (f), for example with dry nitrogen or with dry argon. Suitable flushing—or purging—times are 1 second to 20 minutes. It is preferred that the amount of inert gas is sufficient to exchange the contents of the reactor of from one to 15 times. By such flushing or purging, the production of by-products such as separate particles of reaction product of metal amide or alkyl metal compound, respectively, with water can be avoided. In the case of the couple trimethyl aluminum and water, such by-products are methane and alumina or trimethyl aluminum that is not deposited on the particulate material, the latter being an undesired by-product. Said flushing also takes place after step (f), thus before another step (e).

In one embodiment of the present invention, each flushing step between (e) and (f) has a duration in the range of from one second to thirty minutes.

In one embodiment of the present invention, the reactor is evacuated between steps (e) and (f). Said evacuating may also take place after step (f), thus before another step (e). Evacuation in this context includes any pressure reduction, for example 10 to 1,000 mbar (abs), preferably 10 to 500 mbar (abs).

Each of steps (e) and (f) may be carried out in a fixed bed reactor, in a fluidized bed reactor, in a forced flow reactor or in a mixer, for example in a compulsory mixer or in a free-fall mixer. Examples of fluidized bed reactors are spouted bed reactors. Examples of compulsory mixers are ploughshare mixers, paddle mixers and shovel mixers. Preferred are ploughshare mixers. Preferred ploughshare mixers are installed horizontally, the term horizontal referring to the axis around which the mixing element rotates. Preferably, the inventive process is carried out in a shovel mixing tool, in a paddle mixing tool, in a Becker blade mixing tool and, most preferably, in a ploughshare mixer in accordance with the hurling and whirling principle. Free fall mixers are using the gravitational force to achieve mixing. In a preferred embodiment, steps (e) and (f) of the inventive process are carried out in a drum or pipe-shaped vessel that rotates around its horizontal axis. In a more preferred embodiment, steps (e) and (f) of the inventive process are carried out in a rotating vessel that has baffles.

In one embodiment of the present invention, the rotating vessel has in the range of from 2 to 100 baffles, preferably 2 to 20 baffles. Such baffles are preferably flush mount with respect to the vessel wall.

In one embodiment of the present invention, such baffles are axially symmetrically arranged along the rotating vessel, drum, or pipe. The angle with the wall of said rotating vessel is in the range of from 5 to 45°, preferably 10 to 20°. By such arrangement, they can transport coated cathode active material very efficiently through the rotating vessel.

In one embodiment of the present invention, said baffles reach in the range of from 10 to 30% into the rotating vessel, referring to the diameter.

In one embodiment of the present invention, said baffles cover in the range of from 10 to 100%, preferably 30 to 80% of the entire length of the rotating vessel. In this context, the term length is parallel to the axis of rotation.

In a preferred embodiment of the present invention the inventive process comprises the step of removing the coated material from the vessel or vessels, respectively, by pneumatic conveying, e.g. 20 to 100 m/s.

In one embodiment of the present invention, the exhaust gasses are treated with water at a pressure above one bar and even more preferably higher than in the reactor in which steps (e) and (f) are performed, for example in the range of from 1.010 to 2.1 bar, preferably in the range of from 1.005 to 1.150 bar. The elevated pressure is advantageous to compensate for the pressure loss in the exhaust lines.

The sequence of steps (e) and (f) may be repeated twice to 4 times, wherein in the last sequence of steps (e) and (f), moisture may be least partially substituted by an oxidizing agent. Examples of oxidizing agents are oxygen, peroxides like H₂O₂, and ozone, and combinations of at least two of the foregoing. Particularly preferred oxidizing agents are ozone and mixtures from oxygen and ozone. Such oxidizing agent may be applied in pure form or in combination with moisture.

Said latter step (f) in which moisture may be least partially substituted by an oxidizing agent is hereinafter also referred to as step (f*).

Repetition may include repeating a sequence of steps (e) and (f) each time under exactly the same conditions or under modified conditions but still within the range of the above definitions. For example, each step (e) may be performed under exactly the same conditions, or, e.g., each step (e) may be performed under different temperature conditions or with a different duration, for example 120° C., then 10° C. and 160° C. each from 1 second to 1 hour.

In step (f*), an oxidizing agent replaces moisture at least partially. It is preferred that in step (f*) no humidity is applied, and moisture is fully replaced by an oxidizing agent.

Ozone may be generated from oxygen under conditions known per se, and therefore, in step (f*) ozone usually is applied in the presence of oxygen. During the application of ozone in step (f*) it is preferred that no nitrogen is present.

In one embodiment of the present invention, step (f*) is performed at normal pressure. In another embodiment of the present invention, step (f*) is performed at a pressure of 5 mbar to 1 bar above normal pressure, preferably 10 to 250 mbar above normal pressure. In another embodiment, step (f*) is performed at a pressure below normal pressure, for example at 100 to 900 mbar, preferably at 100 to 500 mbar below normal pressure. Step (f*) may be performed at temperatures from 20 to 300° C., preferred is from 100 to 300° C. and more preferred 150 to 250° C.

In one embodiment of the present invention, the duration of step (f*) is in the range of from 1 second to 2 hours, preferably from 1 second up to 30 minutes.

Step (f*) may be performed in the same type of vessel as step (f). Preferably, steps (f) and (f*) are performed in the same vessel.

A particulate electrode active material is obtained.

In one embodiment of the present invention, the sequence of step (e) and step (f*) is performed only once. In another embodiment, the sequence of step (e) and step (f*) is performed two to five times.

In one embodiment of the present invention, after step (f)—or (f*), as the case may be—a post-treatment is performed, for example a thermal post-treatment (g). Such thermal post-treatment (g) may be performed by treating the particulate electrode active material obtained after step (f) or (f*), respectively, at a temperature in the range of from 150 to 800° C., preferably from 150 to 400° C., for example over a period of time in the range of from preferably from 180 to 350° C., for example over a period of 10 minutes to 2 hours.

in one embodiment of the present invention, after step (d) a post-treatment is performed, for example a thermal post-treatment (d*). Such thermal post-treatment (d*) may be performed by treating the particulate electrode active material obtained after step (d) at a temperature in the range of from 150 to 800° C., preferably from 150 to 400° C., for example over a period of time in the range of from preferably from 180 to 350° C., for example over a period of 10 minutes to 2 hours.

By performing the inventive process electrode active materials may be obtained that display excellent electrochemical properties.

A further aspect of the present invention relates to electrode active materials, hereinafter also related to inventive electrode active material. Inventive electrode active material correspond to general formula Li₁₊ₓ₁TM₁₋ₓ₁O₂, wherein TM contains a combination of Ni and at least one transition metal selected from Co and Mn, and, optionally, at least one metal selected from Al, Ba, and Mg, and, optionally, one or more transition metals other than Ni, Co, and Mn, wherein at least 75 mole-% of TM is Ni, and x1 is in the range of from −0.01 to 0.1. The formula of TM refers to said inventive electrode active material without the coating. In addition, inventive electrode active materials have a specific surface (BET) in the range of from 0.3 to 1.5 m²/g and contains an at least partial coating of 100 to 1,500 ppm of Al. The amounts of ppm refer to ppm by weight.

In a preferred embodiment of the present invention, inventive electrode active materials contain a sum of LiOH and Li2CO3 in the range of from 0.05 to 0.15% by weight, referring to said electrode active material. The amounts of LiOH and Li2CO3 may be determined, e.g., by titration methods.

In one embodiment of the present invention inventive electrode active materials have an average particle diameter (D50) in the range of from 3 to 20 μm, preferably from 5 to 16 μm. The average particle diameter may be determined, e. g., by light scattering or LASER diffraction or electroacoustic spectroscopy. The particles are usually composed of agglomerates from primary particles, and the above particle diameter refers to the secondary particle diameter.

In a preferred embodiment, in compounds according to general formula (I)

Li₍₁₊ₓ₁₎[TM]₍₁₋ₓ₁₎O₂ (I)

TM is (NiₐCo_{b}Mn_{c}M³_{d})

M³ is selected from Ca, Mg, Al and Ba,

and the further variables are defined as above.

In a particularly preferred embodiment, TM is a combination of metals according to general formula (I a)

(NiₐCo_{b}Mn_{c})_{1-d}M¹_{d} (I a)

with a+b+c=1 and

a being in the range of from 0.75 to 0.95,

b being in the range of from 0.025 to 0.2,

c being in the range of from 0.025 to 0.2, and

d being in the range of from zero to 0.1,

and M¹ is at least one of Al, Mg, W, Mo, Nb, Ti or Zr.

In Li₁₊ₓ(CoₑMn_{f}M³_{d})₁₋ₓO₂, e is in the range of from 0.2 to 0.8, f is in the range of from 0.2 to 0.8, the variables M³ and d and x are as defined above, and e+f+d=1.

In other embodiments, TM is a combination of metals according to general formula (I b)

[NiₕCoᵢAlⱼ] (I b)

wherein

h is in the range of from 0.8 to 0.95,

i is in the range of from 0.025 to 0.19, and

j is in the range of from 0.01 to 0.05.

A further aspect of the present invention refers to electrodes comprising at least one electrode material active according to the present invention. They are particularly useful for lithium ion batteries. Lithium ion batteries comprising at least one electrode according to the present invention exhibit a good discharge behavior. Electrodes comprising at least one electrode active material according to the present invention are hereinafter also referred to as inventive cathodes or cathodes according to the present invention.

Cathodes according to the present invention can comprise further components. They can comprise a current collector, such as, but not limited to, an aluminum foil. They can further comprise conductive carbon and a binder.

Suitable binders are preferably selected from organic (co)polymers. Suitable (co)polymers, i.e. homopolymers or copolymers, can be selected, for example, from (co)polymers obtainable by anionic catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol % of copolymerized ethylene and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol % of copolymerized propylene and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder is polybutadiene.

Other suitable binders are selected from polyethylene oxide (PEO), cellulose, carboxymethyl-cellulose, polyimides and polyvinyl alcohol.

In one embodiment of the present invention, binder is selected from those (co)polymers which have an average molecular weight M_{w} in the range from 50,000 to 1,000,000 g/mol, preferably to 500,000 g/mol.

Binder may be cross-linked or non-cross-linked (co)polymers.

In a particularly preferred embodiment of the present invention, binder is selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, more preferably at least two halogen atoms or at least two fluorine atoms per molecule. Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

Inventive cathodes may comprise 1 to 15% by weight of binder(s), referring to electrode active material. In other embodiments, inventive cathodes may comprise 0.1 up to less than 1% by weight of binder(s).

A further aspect of the present invention is a battery, containing at least one cathode comprising inventive electrode active material, carbon, and binder, at least one anode, and at least one electrolyte.

Embodiments of inventive cathodes have been described above in detail.

Said anode may contain at least one anode active material, such as carbon (graphite), TiO₂, lithium titanium oxide, silicon or tin. Said anode may additionally contain a current collector, for example a metal foil such as a copper foil.

Said electrolyte may comprise at least one non-aqueous solvent, at least one electrolyte salt and, optionally, additives.

Nonaqueous solvents for electrolytes can be liquid or solid at room temperature and is preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Polyethylene glycols can here comprise up to 20 mol % of one or more C₁-C₄-alkylene glycols. Polyalkylene glycols are preferably polyalkylene glycols having two methyl or ethyl end caps.

The molecular weight M_{w} of suitable polyalkylene glycols and in particular suitable polyethylene glycols can be at least 400 g/mol.

The molecular weight M_{w} of suitable polyalkylene glycols and in particular suitable polyethylene glycols can be up to 5 000 000 g/mol, preferably up to 2 000 000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and in particular 1,3-dioxolane.

Examples of suitable acyclic organic carbonates are dimethyl carbonate, ethyl methyl carbonate and diethyl carbonate.

Examples of suitable cyclic organic carbonates are compounds according to the general formulae (II) and (III)

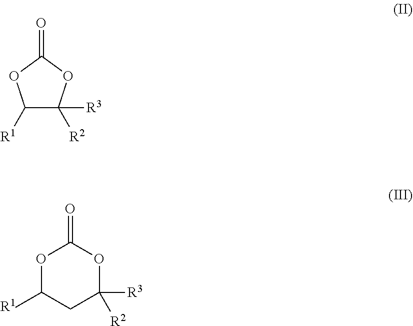

where R¹, R² and R³ can be identical or different and are selected from among hydrogen and C₁-C₄-alkyl, for example methyl, ethyl, n-propyl, isopropyl, n-butyl, isobutyl, sec-butyl and tert-butyl, with R² and R³ preferably not both being tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (IV).

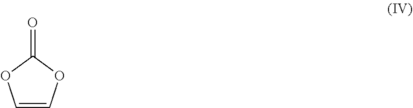

The solvent or solvents is/are preferably used in the water-free state, i.e. with a water content in the range from 1 ppm to 0.1% by weight, which can be determined, for example, by Karl-Fischer titration.

Electrolyte (C) further comprises at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CnF₂ₙ₊₁SO₂)₂, where n is an integer in the range from 1 to 20, LiN(SO₂F)₂, Li₂SiF₆, LiSbF₆, LiAlCl₄ and salts of the general formula (CₙF₂ₙ₊₁SO₂)ₜYLi, where m is defined as follows:

t=1, when Y is selected from among oxygen and sulfur,

t=2, when Y is selected from among nitrogen and phosphorus, and

t=3, when Y is selected from among carbon and silicon.

Preferred electrolyte salts are selected from among LiC(CF₃SO₂)₃, LiN(CF₃SO₂)₂, LiPF₆, LiBF₄, LiClO₄, with particular preference being given to LiPF₆ and LiN(CF₃SO₂)₂.

In an embodiment of the present invention, batteries according to the invention comprise one or more separators by means of which the electrodes are mechanically separated. Suitable separators are polymer films, in particular porous polymer films, which are unreactive toward metallic lithium. Particularly suitable materials for separators are polyolefins, in particular film-forming porous polyethylene and film-forming porous polypropylene.

Separators composed of polyolefin, in particular polyethylene or polypropylene, can have a porosity in the range from 35 to 45%. Suitable pore diameters are, for example, in the range from 30 to 500 nm.

In another embodiment of the present invention, separators can be selected from among PET nonwovens filled with inorganic particles. Such separators can have porosities in the range from 40 to 55%. Suitable pore diameters are, for example, in the range from 80 to 750 nm.

Batteries according to the invention further comprise a housing which can have any shape, for example cuboidal or the shape of a cylindrical disk or a cylindrical can. In one variant, a metal foil configured as a pouch is used as housing.

Batteries according to the invention display a good discharge behavior, for example at low temperatures (zero ° C. or below, for example down to −10° C. or even less), a very good discharge and cycling behavior.

Batteries according to the invention can comprise two or more electrochemical cells that combined with one another, for example can be connected in series or connected in parallel. Connection in series is preferred. In batteries according to the present invention, at least one of the electrochemical cells contains at least one cathode according to the invention. Preferably, in electrochemical cells according to the present invention, the majority of the electrochemical cells contains a cathode according to the present invention. Even more preferably, in batteries according to the present invention all the electrochemical cells contain cathodes according to the present invention.

The present invention further provides for the use of batteries according to the invention in appliances, in particular in mobile appliances. Examples of mobile appliances are vehicles, for example automobiles, bicycles, aircraft or water vehicles such as boats or ships. Other examples of mobile appliances are those which move manually, for example computers, especially laptops, telephones or electric hand tools, for example in the building sector, especially drills, battery-powered screwdrivers or battery-powered staplers.

The invention is further illustrated by the following non-limiting working examples.

sccm: standard cubic centimeters per minute, cubic centimeters under standard conditions: 1 atm and 20° C.

I. Synthesis of a cathode active material

1.1 Synthesis of a precursor TM-OH.1

A stirred tank reactor was filled with deionized water and 49 g of ammonium sulfate per kg of water. The solution was tempered to 55° C. and a pH value of 12 was adjusted by adding an aqueous sodium hydroxide solution.

The co-precipitation reaction was started by simultaneously feeding an aqueous transition metal sulfate solution and aqueous sodium hydroxide solution at a flow rate ratio of 1.8, and a total flow rate resulting in a residence time of 8 hours. The transition metal solution contained Ni, Co and Mn at a molar ratio of 8.5:1.0:0.5 and a total transition metal concentration of 1.65 mol/kg. The aqueous sodium hydroxide solution was a 25 wt. % sodium hydroxide solution and 25 wt. % ammonia solution in a weight ratio of 6. The pH value was kept at 12 by the separate feed of an aqueous sodium hydroxide solution. Beginning with the start-up of all feeds, mother liquor was removed continuously. After 33 hours all feed flows were stopped. The mixed transition metal (TM) oxyhydroxide precursor TM-OH.1 as obtained by filtration of the resulting suspension, washing with distilled water, drying at 120° C. in air and sieving.

1.2 Conversion of TM-OH.1 into a cathode active materials, and treatment according to the inventive process

1.2.1 Manufacture of a comparative cathode active material, C-CAM.1, step (a.1)

C-CAM.1: The mixed transition metal oxyhydroxide precursor obtained according to 1.1 was mixed with LiOH monohydrate to obtain a Li/(TM) molar ratio of 1.05. The mixture was heated to 760° C. and kept for 10 hours in a forced flow of a mixture of 60% oxygen and 40% nitrogen (by volume). After cooling to ambient temperature the powder was deagglomerated and sieved through a 32 μm mesh to obtain the electrode active material C-CAM 1.

D50=9.0 μm determined using the technique of laser diffraction in a Mastersize 3000 instrument from Malvern Instruments Residual moisture at 250° C. was determined to be 300 ppm.

1.2.2 Treatment with an aqueous medium, steps (b.1) and (c.1) and (d.1)

C-CAM.1 was added to demineralized water at ambient temperature in a weight ratio of 1.5 (CAM:water). After 2 minutes of stirring of the resultant slurry the liquid was removed by filtration through a Büchner funnel. The filter cake so obtained was dried at 65° C. in a membrane pump vacuum for 2 hours followed by a 2^{nd} drying step at 180° C. for 10 hours in membrane pump vacuum as well. CAM.1-W was obtained.

1.2.3 Aluminum oxide coating, steps (e.1) and (f.1)

A fluidized bed reactor with external heating jacket was charged with 100 g of CAM.1-W, and at an average pressure of 130 mbar, C-CAM.1-W was fluidized. The fluidized bed reactor was heated to 180° C. and kept at 180° C. for 3 h. Trimethylaluminum (TMA) in the gaseous state was introduced into the fluidized bed reactor through a filter plater by opening a valve to a precursor reservoir that contained TMA in liquid form and that was kept at 50° C. The TMA was diluted with nitrogen as carrier gas. The gas flow of TMA and N₂ was 10 sccm. After a reaction period of 210 seconds non-reacted TMA was removed through the nitrogen stream, and the reactor was purged with nitrogen for 15 minutes with a flow of 30 sccm. Then, water in the gaseous state was introduced into the fluidized bed reactor by opening a valve to a reservoir that contained liquid water kept at 24° C., flow: 10 sccm. After a reaction period of 120 seconds non-reacted water was removed through a nitrogen stream, and the reactor was purged with nitrogen, 15 minutes at 30 sccm. The above sequence was repeated for three times. The reactor was cooled to 25° C. and the material was discharged. The resultant CAM.2 displayed the following properties: D50=10.6 μm determined using the technique of laser diffraction in a Mastersize 3000 instrument from Malvern Instruments. Al-content: 1,400 ppm, determined by inductively coupled plasma—emission spectroscopy (ICP-OES) with a PE-Optima 3300 RL instrument (typical detection limit of 3 ppm) via quantitation against a standard solution. Residual moisture at 250° C. was determined to be 200 ppm.

Inventive CAM.2 shows excellent electrochemical properties.

1. A process for making a coated oxide material, comprising the following steps:
(a) providing a particulate material chosen from lithiated nickel-cobalt aluminum oxides, lithium cobalt oxide, lithiated cobalt-manganese oxides, and lithiated layered nickel-cobalt-manganese oxides,
(b) treating the particulate material with an aqueous medium,
(c) removing the aqueous medium,
(d) drying the treated particulate material,
(e) treating the particulate material from step (d) with a metal amide or alkyl metal compound,
(f) treating the material obtained in step (e) with moisture or an oxidizing agent,
and, optionally, repeating the sequence of steps (e) and (f).

2. The process according to claim 1, wherein the particulate material has the formula Li₁₊ₓTM₁₋ₓO₂, wherein TM comprises a combination of Ni and at least one transition metal chosen from Co and Mn, and, optionally, at least one metal chosen from Al, B, Ba, and Mg and, optionally, one or more transition metals other than Ni, Co, and Mn, and x ranges from −0.05 to 0.2.

3. The process according to claim 1. wherein at least 75 mole-% of TM is Ni.

4. The process according to claim 1, wherein steps (e) and (f) are carried out in a gas phase.

5. The process according to claim 1, wherein steps (e) and (f) are carried out in a mixer, moving bed, or fixed bed.

6. The process according to claim 1, wherein step (b) is performed at a temperature ranging from 10° C. to 80° C.

7. The process according to claim 1, wherein TM is a combination of metals according to general formula (I a)
(NiₐCo_{b}Mn_{c})_{1-d}M¹_{d} (I a)
with a+b+c=1 and
a ranges from 0.75 to 0.95,
b ranges from 0.025 to 0.2,
c ranges from 0.025 to 0.2,
d ranges from zero to 0.1,
M¹ is at least one of Al, Mg, W, Mo, Nb, Ti or Zr.

8. The process according to claim 1, wherein TM is a combination of metals according to general formula (I b)
[NiₕCoᵢAlⱼ] (I b)
wherein
h ranges from 0.8 to 0.95,
i ranges from 0.025 to 0.19, and
j ranges from 0.01 to 0.05.

9. The process according to claim 1, wherein step (d) is performed at a temperature ranging from 100° C. to 300° C.

10. The process according to claim 1, wherein step (d) is followed by a thermal treatment step (d*) comprising treating at a temperature ranging from 300° C. to 700° C.

11. The process according to claim 1, wherein step (f) is followed by a subsequent thermal treatment step (g) comprising treating the material obtained after step (f) at a temperature ranging from 300° C. to 700° C.

12. An electrode active material according to general formula Li₁₊ₓ₁TM₁₋ₓ₁O₂, wherein TM comprises a combination of Ni and at least one transition metal chosen from Co and Mn, and, optionally, at least one metal chosen from Al, Ba, and Mg, and, optionally, one or more transition metals other than Ni, Co, and Mn, wherein at least 75 mole-% of TM is Ni, and x1 ranges from −0.01 to 0.1,
wherein the electrode active material has a specific surface (BET) ranging from 0.3 m²/g to 1.5 m²/g and comprises an at least partial coating ranging from 100 ppm to 1,500 ppm of Al.

13. The electrode active material according to claim 12, wherein the electrode active material comprises a sum of LiOH and Li₂CO₃ ranging from 0.05 wt. % to 0.15 wt. % by weight of electrode active material.

14. An electrode comprising at least one particulate electrode active material according to claim 12.
